(19) United States
(12) Patent Application Publication
(10) Pub. No.: US 2022/0087246 A1
(43) Pub. Date: Mar. 24, 2022

(54) DETECTION OF PESTS WITHIN AN INFRASTRUCTURE BY LEVERAGING DIGITAL TWIN

(71) Applicant: International Business Machine Corporation, Armonk, NY (US)

(72) Inventors: Partho Ghosh, Kolkata (IN); Venkata Vara Prasad Karri, Visakhapatnam (IN)

(21) Appl. No.: 17/029,371

(22) Filed: Sep. 23, 2020

(51) Int. Cl. A01M 7/00; G06F 30/20; G16Y 40/35; G16Y 40/10; G16Y 20/10

(52) U.S. Cl. CPC A01M 7/0089; A01M 7/005; G16Y 20/10; G16Y 40/35; G16Y 40/10; G06F 30/20

(57) ABSTRACT

An approach for predicting and/or discovering pest infestation as it impacts building infrastructure by leveraging digital twin computing is disclosed. The approach utilizes digital twin of streets, building, housing complex, community parks and pests. The approach can simulate the optimal breeding condition and sites for pests based on factors such as weather pattern, historical data, real time data, pest data and building design and material. Based on the simulation, the approach can recommend corrective actions to mitigate pests based on the scenarios.

### BACKGROUND

The present invention relates generally to detecting issues within physical infrastructure, and more particularly to detecting pests and the impact of pests as it relates to the physical infrastructure.

Pest and pathogens cost global agriculture $540 billion dollars a year and termites can cause an additional $5 billion a year to homeowners. By identifying an infestation early, farmers or homeowners can take proactive actions (e.g., organic, chemical or physical) to prevent the pest problem from spreading and ruining homes and/or crops.

One of the phase regarding the current method of pest detection typically involves visual identification and frequent monitoring. The other phases involves actual treatment of pests. Regular observation is also critically important. Observation can be broken into inspection and identification steps. Visual inspection, insect traps, and other methods are used to monitor pest levels. In addition, record-keeping is also vitality essential. Furthermore, knowledge target pest behavior, reproductive cycles and ideal temperature. Sometimes, visual identification of the affected area can even be too late (i.e., observing brittle wood due to a colony of termites).

### SUMMARY

Aspects of the present invention disclose a computer-implemented method, a computer system and computer program product for predicting and/or discovering pest infestation as it impacts building infrastructure. The computer implemented method may be implemented by one or more computer processors and may include receiving data associated with a building infrastructure; generating a digital twin copy of the building infrastructure based on the received data; generating pest result data based on simulating one or more pest control scenarios associated with the digital twin copy; analyzing the pest result data; creating an action plan based on analysis; and outputting the action plan.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

### BRIEF DESCRIPTION OF THE DRAWINGS

Preferred embodiments of the present invention will now be described, by way of example only, with reference to the following drawings, in which:

FIG. 1 is a functional block diagram illustrating a high level overview of the safety detection environment, designated as 100, in accordance with an embodiment of the present invention;

FIG. 2 is a functional block diagram illustrating the subcomponents of pest component 111, in accordance with an embodiment of the present invention;

FIG. 3 is a high-level flowchart illustrating the operation of pest component 111, designated as 300, in accordance with an embodiment of the present invention; and

FIG. 4 depicts a block diagram, designated as 400, of components of a server computer capable of executing the pest component 111 within the safety detection environment 100, in accordance with an embodiment of the present invention.

### DETAILED DESCRIPTION

Digital twin computing leverages IoT, artificial intelligence (i.e., leveraging machine/deep learning) and software analytics to create living digital simulation models that update and change as their physical counterparts change. A digital twin continuously learns and updates itself to represent its near real-time status. A digital twin also integrates historical data from past usage to factor into its digital model. What is a simulation? A simulation is an approximation of a process and/or a system (e.g., machines, etc.). Furthermore, simulations are run in virtual environments that may be representations of physical environments but do not integrate real-time data (i.e., used by digital twin computing). The main difference between a simulation (and/or modeling) versus a digital twin is that a digital twin can use real-time data based on the regular transfer of information between the digital twin and its corresponding physical environment.

Embodiments of the present invention provides an approach for predicting and/or discovering pest infestation (e.g., insects, rats, etc.) as it impacts building infrastructure by leveraging digital twin computing. Furthermore, embodiment can be used on any building infrastructure (e.g., industrial plan, hospital, residence, etc.) to identify potential issues (e.g., breeding sites for pests, etc.) as it relates to pest infestation. The approach utilizes digital twin of streets, building, housing complex, community parks to scan for potential conditions breeding sites for insects (e.g., termites, bugs, flies, cockroaches, etc.) The approach can simulate the breeding condition along with upcoming weather conditions (i.e., from weather website/server). Based on the simulation, the approach can recommend corrective actions such as, i) warning public officials to take necessary sanitization steps which would help in eradicating breeding sites and thereby potential insect spread diseases, ii) notify the asset owners, maintenance teams to prepare and plan accordingly (i.e., pest control every year) and a notification one month before a rainy season. For example, a public park, park_A, located in a tropical climate near the equator has the conditions conducive to breeding of mosquitos. Based on the digital twin simulation which consider pest condition factors, such as, i) moisture level, ii) rain forecast and iii) geographic terrain (i.e., not flat where rainwater can collect for mosquito larvae). In another example, a residential house, house_A, located in a temperate climate, the digital twin simulation can predict possible infestation by termites based on the following pest condition factors: i) moisture level, ii) soil condition, and iii) type of wood used for the house. The approach, based on the simulation, can recommend action plan that includes, termite inspection and/or spraying and laying traps for termites. In other embodiments of the present invention, the approach may be used for predicting pest infestation on furniture (e.g., wooden chair, iron table, etc.) in addition to structural damage.

Other embodiments of the present invention may recognize one or more of the following facts, potential problems, potential scenarios, and/or potential areas for improvement with respect to the current state of the art: i) identification of highly impacted place versus less impacted places in the building to plan the budget resources and infrastructure accordingly, ii) alerting the facilities teams, individuals, organizations on timely maintenance of identified building with remedial action plans by the type of breeding/growth identified, iii) scheduling timely preventive maintenance activities based on the metrics derived for each category insect breeding and pest breeding and their exposure to environmental factors like heat, rain water, moisture developed for any reason inside the building etc., iv) identify the need and place/schedule an order/ticket in real-time for registered vendors for maintenance based on ranking of breeding and impact on building, v) feedback system to understand if a particular place or level of moisture or humidity is not detected because of malfunctioning of sensor or low reading then the outlier identified will consider human input via an image or data input to determine next steps, vi) prioritizing certain locations in the building structure for maintenance or potential breeding sights for pests and vii) recommending architectural design changes, materialistic choice, lifestyle changes to prevent infestations of pests breeding for a particular vulnerable portion of a building.

In another embodiment of the present invention can provide an approach for, i) identifying insects and pest breeding sites in a building/city by using digital twin, ii) scheduling timely preventive maintenance activities based on metrics derived for each category insect breeding and pest breeding and iii) alerting individuals, facilities teams, organizations on timely maintenance of identified real estate with remedial action plans by the type of breeding or growth identified.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

It should be understood that the Figures are merely schematic and are not drawn to scale. It should also be understood that the same reference numerals are used throughout the Figures to indicate the same or similar parts.

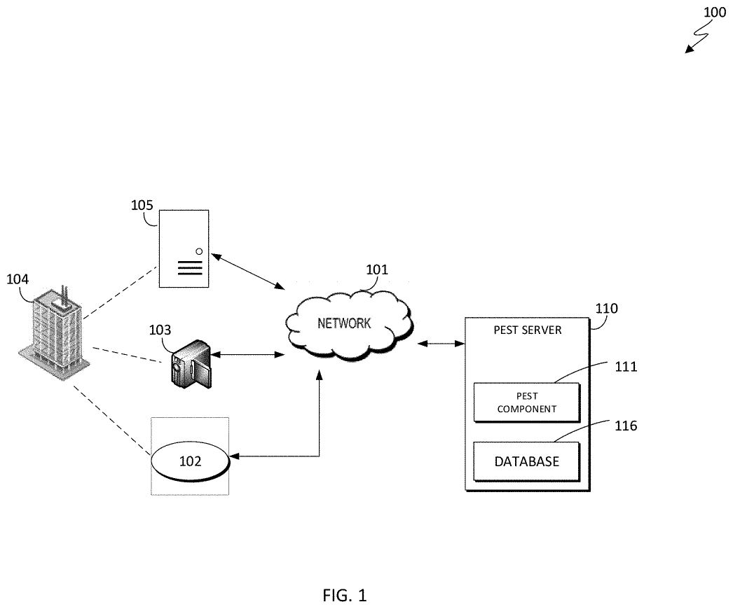

FIG. 1 is a functional block diagram illustrating a safety detection environment 100 in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Safety detection environment 100 includes network 101, anti-pest device 102, sensors 103, building 104, digital twin server 105 and pest server 110.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between pest server 110, sensors 103, anti-pest device 102 and other computing devices (not shown) within safety detection environment 100. It is noted that other computing devices can include, but is not limited to, anti-pest device 102 and any electromechanical devices capable of carrying out a series of computing instructions.

Anti-pest device 102 can be an electro-mechanic device capable of executing instructions from pest server 110. Anti-pest device 102 can include autonomous robotic vacuum cleaner, smart light, UV light and ultrasonic smart pest repellent.

Sensors 103 can be any smart device (e.g., IoT, IP camera, etc.) used for detecting objects, chemical compounds/elements, auditory signals, electromagnetic signal and images. Sensors 103 can include IoT devices, such as, cameras, olfactory, thermal sensors/imaging, microphones and chemical detectors.

Building 104 can be any building and/or structure (e.g., industrial plant, residence, etc.) being analyzed and/or copied for digital twin representation by the embodiment.

Digital twin server 105 can be servers used to simulate the digital twin of building 104. Digital twin server can communicate with sensors 103 to update the simulation status. Furthermore, digital twin server 105 can communicate with other computing devices (not shown) in order to leverage artificial intelligence capabilities of the integrated workplace management system (IWMS) and Asset Performance Management (APM) platforms. IWMS is a software platform (i.e., IBM TRIRIGA®) that helps organizations optimize the use of workplace resources, including the management of a company's building portfolio, infrastructure and facilities assets. IWMS solutions are commonly packaged as a fully integrated suite or as individual modules that can be scaled over time. They are used by corporate occupiers, building services firms, facilities services providers, landlords and managing agents. APM system are used to improve the reliability and availability of physical assets while minimizing risk and operating costs. APM platforms, such as, IBM Maximo®, typically includes condition monitoring, predictive maintenance, asset integrity management, reliability-centered maintenance, and often involves technologies such as asset health data collection, visualization, and analytics. APM can be used in conjunction with EAM (enterprise assessment management) system for a complete and holistic management of business objective.

Pest server 110 and digital twin server 105 can be a standalone computing device, a management server, a web server, a mobile computing device, or any other electronic device or computing system capable of receiving, sending, and processing data. In other embodiments, pest server 110 and digital twin server 105 can represent a server computing system utilizing multiple computers as a server system, such as in a cloud computing environment. In another embodiment, pest server 110 and digital twin server 105 can be a laptop computer, a tablet computer, a netbook computer, a personal computer (PC), a desktop computer, a personal digital assistant (PDA), a smart phone, or any other programmable electronic device capable of communicating other computing devices (not shown) within safety detection environment 100 via network 101. In another embodiment, pest server 110 and digital twin server 105 represents a computing system utilizing clustered computers and components (e.g., database server computers, application server computers, etc.) that act as a single pool of seamless resources when accessed within safety detection environment 100.

Embodiment of the present invention can reside on pest server 110. Pest server 110 includes pest component 111 and database 116.

Pest component 111 provides the capability of gathering historical and/or real-time data from sensors 103 (and other sources such as social media and crowd source) associated with the building (e.g., industry plant, hospital, house, etc.) combined with a corpus knowledge of pest and running a simulation using twin digital computing. Pest component 111, based on the result of the simulation, can make create an action plan based on the result (e.g., recommend pest removal/spraying, recommend replacing certain materials of the structure less conducive for pests, etc.).

Database 116 is a repository for data used by pest component 111. Database 116 can be implemented with any type of storage device capable of storing data and configuration files that can be accessed and utilized by pest server 110, such as a database server, a hard disk drive, or a flash memory. Database 116 uses one or more of a plurality of techniques known in the art to store a plurality of information. In the depicted embodiment, database 116 resides on pest server 110. In another embodiment, database 116 may reside elsewhere within safety detection environment 100, provided that pest component 111 has access to database 116. Database 116 may store information associated with, but is not limited to, knowledge corpus, i) building materials used within the infrastructure, ii) pest information (e.g., favorite food, natural enemies, breeding patterns, etc.), iii) vegetation surrounding the facility, iv) weather pattern associated with the facility, v) historical pest control plan and actions , vi) regional demographic data and its effect on different types of objects inside the home and vii) infrastructure data (e.g., blueprint, HVAC diagram, blueprint, etc.).

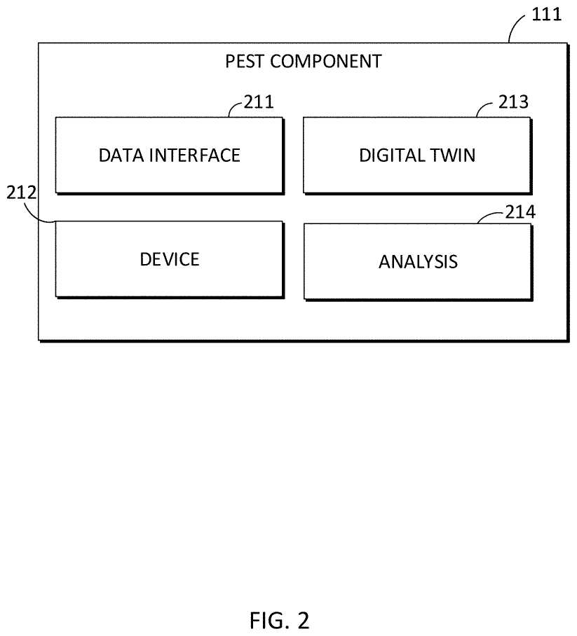

FIG. 2 is a functional block diagram illustrating pest component 111 in accordance with an embodiment of the present invention. In the depicted embodiment, pest component 111 includes data interface component 211, device component 212, digital twin component 213 and analysis component 214.

As is further described herein below, data interface component 211 of the present invention provides the capability of communicating with data servers (i.e., IWMS, APM servers, etc.) to obtain relevant information associated with a particular building/plant. The relevant information can include, but it is not limited to, building size, specifications related to all materials used throughout the building, date of installation and date of previous pest inspection. It is noted that data provided by the IWMS and/or APM system could be used to feed into digital twin component 213 and/or directly to digital twin server 105.

As is further described herein below, device component 212 of the present invention provides the capability of communicating with sensors (i.e., sensors 103) to obtain real-time and/or historical information associated with various sensors (e.g., IoT devices, moisture, temperature, soil sensors, thermal camera, microphones, etc.) attached to the building/plant. Sensors 103 can be used on furniture. For example, olfactory/chemical detecting sensors (i.e., odor sensor) on bed and/or mattress for detection of potential bed bug manifestations and breeding.

The information from device component 212 can further be communicated to digital twin server 105 and/or digital twin component 213.

Furthermore, device component 212 has the capability of communicating and control anti-pest device 102. For example, device component 212 can guide the robotic vacuum cleaner (i.e., equipped with auto roach spray) to the targeted location to decontaminate potential cockroach areas. In another example, device component 212 can activate a smart UV laser/light to de-contaminate mattress that may have bed bugs/mites. In yet another example, device component 212 can turn smart ultrasonic soundwave device upon the detection/identification of mosquitos.

As is further described herein below, digital twin component 213 of the present invention provides the capability of communicating with digital twin server 105. Digital twin component 314, can run simulations, with AI, of various scenarios on digital twin server 105. Scenarios can include: i) using weather data (i.e., geospatial data of the corresponding building entity), digital twin component 213 can simulate breeding conditioning patterns of a potential pest manifestation, ii) identify clogging patterns of the water based on simulation of a weather pattern (i.e., integrated with weather data), and humidity/moisture conditions of an indoor room, geographical and location whether conditions and thereby identify potential insect attacks and sites for pests breeding (e.g., mosquito, cockroach, rats, termites, etc.), iii) identify breeding sites of pest based on acoustic and olfactory/chemical sensors (i.e., certain pests emits particular and distinct odor/chemical signature), iv) identifying breeding pest sites based on thermal imaging (from thermal sensors). Scenarios can rely on data, including factors, from database 116 or other external sources (e.g., IoT sensors, weather server, etc.). Some factors can include, i) internal structure, 2) pest data, 3) external environment. Internal structure factor can include materials used for the building infrastructure. Pest data factor can include, breeding data, life cycle, food, and natural enemies. External environment factor can include, weather pattern, regional demographic data and its effect on different types of objects inside a structure.

Furthermore, digital twin component 213 can, through device component 212, receive data from various IoT devices and other sensors to provide real-time data to update the digital twin copy.

As is further described herein below, analysis component 214 of the present invention provides the capability of analyzing data from digital twin component 213 based on the simulation runs. Analysis component 214 can perform the following, but is not limited to, function, including making recommendations, creating action plan (e.g., maintenance plan, etc.) and executing action plan based on the analysis (i.e., pest result data). For example, analysis component 214 can identify and recommend strategic location for placement of IoT device and sensors within a structure (i.e., building 104) covering the most susceptible points based on historical readings obtained from installations and other factors.

An action plan can include recommendation to utilize smart light during off-usage hours of the building and indoors (floors). In another example, analysis component 214 can recommend architectural design changes and materialistic choice changes to prevent and/or make it less ideal for breeding of pests at the targeted building (e.g., too much accumulation of rainwater based on the slope of the roof, lack of anti-algae paint, etc.) based on factors, such as, historical weather, humidity/moisture content, seasonal conditions, usage key indexes and environmental exposure. Furthermore, analysis component 214 can suggest ideal for building construction materials to prevent ideal condition for pest breeding. Another example of an action plan can include recommending a certain temperature setting inside the infrastructure to deter certain pest from breeding (e.g., keep the house cold at 68 to prevent mosquitos, etc.).

In yet another example, analysis component 214 can identifying the material passage ingredients, such as, i) outlet from washing machine, ii) outlet from dishwasher and iii) washing of green vegetable that may be ideal situation/scenario for a creating a breeding environment for pest manifestation.

A maintenance plan, by analysis component 214, can include, but it is not limited to, recommendation for maintenance (of a building infrastructure) as it relates to i)material replacement and repair, ii) periodic inspections, iii) anti-contaminators based on potential insect breeding conditions and devices to control insect manifestations (e.g., non-lethal rat trap, mosquito repellent, insect repellent plants, etc.).

In other embodiment, analysis component 214 can send data from digital twin component 314 to a remote system (e.g., IWMS, APM, etc.) for further analysis and action. The analysis performed from remote system (i.e., belonging to service centers/vendor) will be done in a periodic basis to identify the types of problem and the reason of problem with pest infestation.

In another embodiment, analysis component 214 can send a robotic drone equipped with anti-pest chemical to spray certain areas to mitigate potential breeding sites or can spray chemicals to neutralize current infestations.

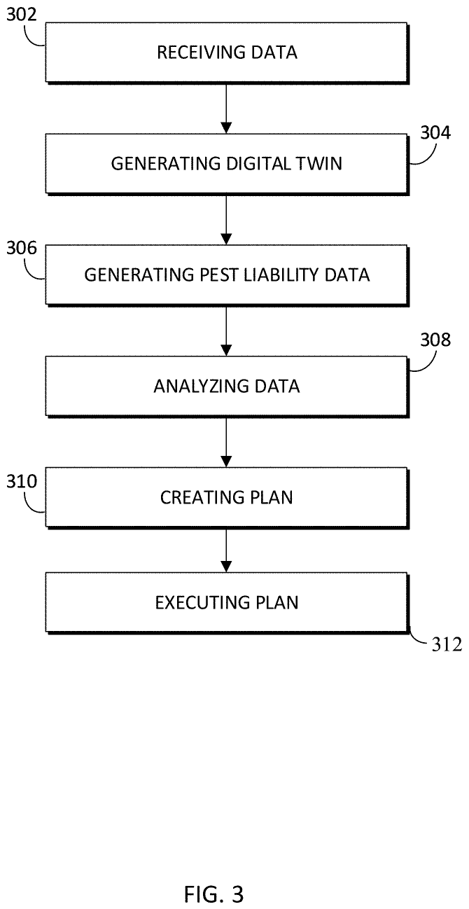

FIG. 3 is a flowchart illustrating the operation of pest component 111, designated as 300, in accordance with another embodiment of the present invention.

Pest component 111 receives data (step 302). In an embodiment, pest component 111, receives from data interface component 211 associated with the target infrastructure. For example, building_A, an office building, located in a tropical climate zone, is selected for digital twin creation. User request and receives various data (e.g., schematic, floor plan, materials, etc.) from various database, anti-pest device 102 and including IoT devices (i.e., sensors 103) relating to building_A.

Pest component 111 generates digital twin (step 304). In an embodiment, pest component 111, through digital twin component 213, creates digital twin copy of the target infrastructure (i.e., building 104). For example, using the prior example, data from sensors 103 and/or from IWMS/APM system is used by digital twin server 105 to create an exact digital replica of building_A.

Pest component 111 generates pest liability data (step 306). In an embodiment, pest component 111, through digital twin component 213, initiate several simulations and scenarios related to pest infestations, ideal pest breeding condition, weather pattern affecting pest breeding, etc. on the digital twin copy of building_A. A pest liability data is generated based on the analysis.

Pest component 111 analyzes pest liability data (step 308). In an embodiment, pest component 111, through analysis component 214, analyzes the pest liability data generated by the scenarios/simulations. For example, using the prior example, a pest liability data indicates a potential mosquito breeding area on the northwest corner of the house, next to the rain gutter, based on several factors: i) the rain gutter does not extend far enough from the house to evacuate the water, ii) the slope of the ground next to that rain gutter, iii) the angle of the rain gutter exit, iv) the tree and bush obscures the rain gutter from the sun and would not aid in evaporation and iv) soil composition next to the rain gutter does not absorb water quickly.

Pest component 111 creates a plan (step 310). In an embodiment, pest component 111, through analysis component 214, create an action plan based on the pest liability data. For example, using the prior example, analysis component 214 recommends the following action plan on the northeast rain gutter, i)trim the branches and bushes surrounding the gutter and ii) extend a pipe underneath the ground to diver the rain water from the gutter all the way to the nearest storm water drain (by the front of the house).

It is noted that the action plan can be created by pest component 111 or created by IWMS and/or APM system.

Pest component 111 executes the plan (step 312). In an embodiment, pest component 111, through analysis component 214 and/or device component 212 may execute the action plan by sending instructions to a facility management company and/or to an IWMS/APM system. For example, analysis component 214 sends a P.O. (purchase order) to a local landscaping vendor with a due date. The landscape vendor acknowledge the due date and fee and sends a construction crew to perform the job on a specified date.

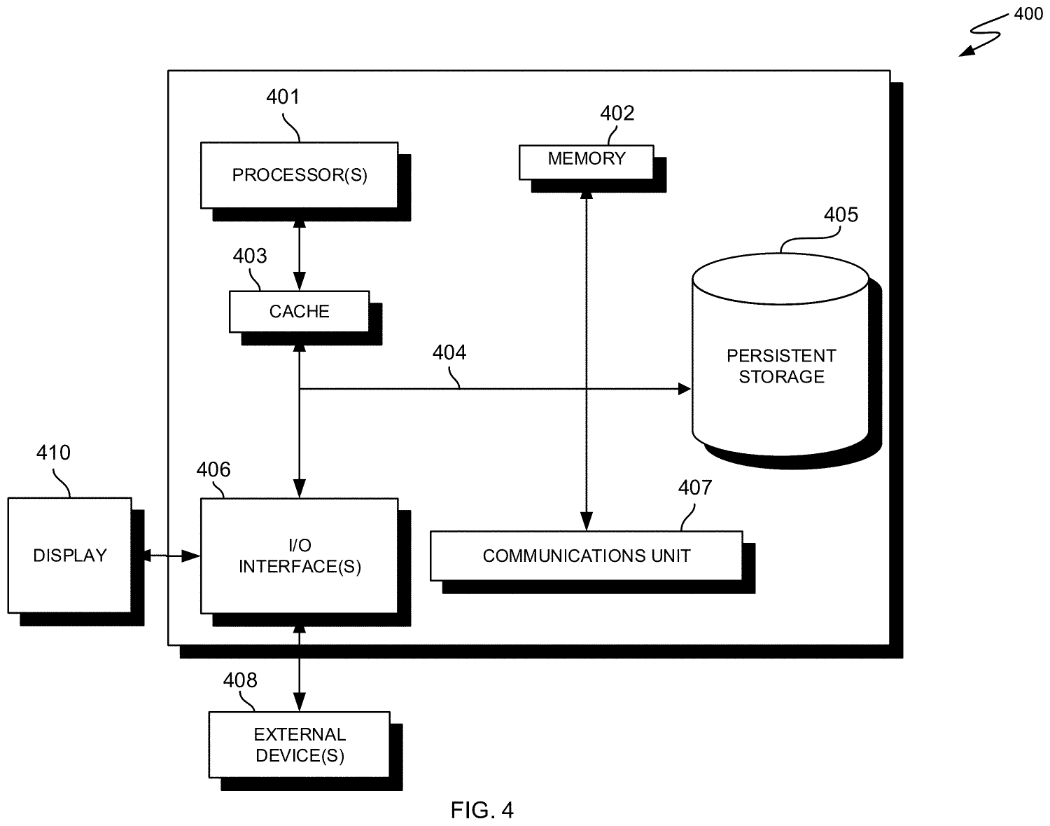

FIG. 4, designated as 400, depicts a block diagram of components of pest component 111 application, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

FIG. 4 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data x10) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Pest component 111 can be stored in persistent storage 405 for access and/or execution by one or more of the respective processor(s) 401 via cache 403.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., Pest component 111) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., Pest component 111) used to practice embodiments of the present invention can be stored on such portable computer readable storage media and can be loaded onto persistent storage 405 via I/O interface(s) 406. I/O interface(s) 406 also connect to display 410.

Display 410 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. I t will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for predicting and/or discovering pest infestation as it impacts building infrastructure, the computer-implemented method comprising:
receiving data associated with a building infrastructure;
generating a digital twin copy of the building infrastructure based on the received data;
generating pest result data based on simulating one or more pest control scenarios associated with the digital twin copy;
analyzing the pest result data;
creating an action plan based on analysis; and
outputting the action plan.

2. The computer-implemented method of claim 1, wherein the received data further comprises of infrastructure data, pest data, weather data, historical pest control data.

3. The computer-implemented method of claim 1, simulating the one or more pest control scenarios further comprises:
creating the one or more pest control scenarios based on the digital twin copy of the building infrastructure, the received data and real-time IOT data.

4. The computer-implemented method of claim 1, wherein the one or more pest control scenarios further comprises of a breeding condition and sites of pests and identify clogging patterns.

5. The computer-implemented method of claim 1, wherein the pest result data further comprises of recommendations of susceptible points to place IoT sensors.

6. The computer-implemented method of claim 1, wherein the action plan further comprises of recommending a certain temperature setting and making architectural design changes.

7. The computer-implemented method of claim 1, wherein outputting the action plan further comprises:
sending a drone to spray areas with chemicals to mitigate breeding.

8. A computer program product for predicting and/or discovering pest infestation as it impacts building infrastructure, the computer program product comprising:
one or more computer readable storage media and program instructions stored on the one or more computer readable storage media, the program instructions comprising:
program instructions to receive data associated with a building infrastructure;
program instructions to generate a digital twin copy of the building infrastructure based on the received data;
program instructions to generate pest result data based on simulating one or more pest control scenarios associated with the digital twin copy;
program instructions to analyze the pest result data;
program instructions to create an action plan based on analysis; and
program instructions to output the action plan.

9. The computer program product of claim 8, wherein the received data further comprises of infrastructure data, pest data, weather data, historical pest control data.

10. The computer program product of claim 8, program instructions to simulate the one or more pest control scenarios further comprises:
program instructions to create the one or more pest control scenarios based on the digital twin copy of the building infrastructure, the received data and real-time IOT data.

11. The computer program product of claim 8, wherein the one or more pest control scenarios further comprises of a breeding condition and sites of pests and identify clogging patterns.

12. The computer program product of claim 8, wherein the pest result data further comprises of recommendations of susceptible points to place IoT sensors.

13. The computer program product of claim 8, wherein the action plan further comprises of recommending a certain temperature setting and making architectural design changes.

14. The computer program product of claim 8, wherein program instructions to output the action plan further comprises:
program instructions to send a drone to spray areas with chemicals to mitigate breeding.

15. A computer system for predicting and/or discovering pest infestation as it impacts building infrastructure, the computer system comprising:
one or more computer processors;
one or more computer readable storage media;
program instructions stored on the one or more computer readable storage media for execution by at least one of the one or more computer processors, the program instructions comprising:
program instructions to receive data associated with a building infrastructure;
program instructions to generate a digital twin copy of the building infrastructure based on the received data;
program instructions to generate pest result data based on simulating one or more pest control scenarios associated with the digital twin copy;
program instructions to analyze the pest result data;
program instructions to create an action plan based on analysis; and
program instructions to output the action plan.

16. The computer system of claim 15, program instructions to simulate the one or more pest control scenarios further comprises:
program instructions to create the one or more pest control scenarios based on the digital twin copy of the building infrastructure, the received data and real-time IOT data.

17. The computer system of claim 15, wherein the one or more pest control scenarios further comprises of a breeding condition and sites of pests and identify clogging patterns.

18. The computer system of claim 15, wherein the pest result data further comprises of recommendations of susceptible points to place IoT sensors.

19. The computer system of claim 15, wherein the action plan further comprises of recommending a certain temperature setting and making architectural design changes.

20. The computer system of claim 15, wherein program instructions to output the action plan further comprises:
program instructions to send a drone to spray areas with chemicals to mitigate breeding.
